(19) United States
(12) Patent Application Publication
(10) Pub. No.: US 2017/0083870 A1
(43) Pub. Date: Mar. 23, 2017

(54) SOCIAL PLANNING

(71) Applicant: Ribbon Labs, Inc., New York, NY (US)

(72) Inventor: Anthony Frank ALFARO, Garden Grove, CA (US)

(21) Appl. No.: 14/860,495

(22) Filed: Sep. 21, 2015

(51) Int. Cl. G06Q 10/10

(52) U.S. Cl. CPC G06Q 10/1095

(57) ABSTRACT

Social planning automation integrates planning, invitee, event, contact and other data into a single system. The creation of a plan for an event immediately anchors a communications thread to a plan object such that the communications and the planning information may be switched between during the planning process. Techniques to present events and/or plans of interest to a user are disclosed including presenting participation of contacts in their respective plans may be presented, and presenting events of interest based on plan data or data entered during the planning process. User interfaces and user interface elements to facilitate social planning techniques are described. Integration of social network data, and data mining are also disclosed.

### BACKGROUND

Planning is the marshalling of people and resources towards a common goal. When that common goal is for multiple persons to participate in a common experience, that common experience is called an event. While marshalling of resources may be complex, it is not as dynamic as the marshalling of people. Unlike resources, people may not be aware of an opportunity to meet let alone aware of an event, may variably change their minds as to participate in an event, or experience other conflicts affecting their ability to participate or the degree they may participate in an event. Accordingly, planning an event involves a degree of complexity suggesting automation.

However, efforts that have been made to automate the event planning process tend to be static or centralized. For example, event planning software typically involves a central planner sending out invitations and tallying responses (RSVPs). Those tools may have poor integration with other time management tools such as calendaring, and do not integrate with content related to the planning process, such as communications and third party information relevant to events and event planning. Furthermore, the effort to manage events with present event planning tools is relatively high, thus informal events are rarely planned with such tools. Accordingly, much data about the events a person may participate in is lost.

Other planning tools, typically features in vertical applications such as customer relations management tools, include meeting planning tools, including for informal meetings such as one-on-one lunches, and telephone calls. However, as with the aforementioned event planning software, the communications threads comprising the planning of the meetings and/or events themselves are not integrated.

### BRIEF DESCRIPTION OF THE DRAWINGS

The Detailed Description is set forth with reference to the accompanying figures.

FIG. 1 is a context diagram of Social Planning.

FIG. 2 is a flow chart of an exemplary hardware, software and communications environment for Social Planning.

FIG. 3 is an exemplary architecture diagram for Social Planning.

FIG. 4 is a flow chart of integration of communications threads in Social Planning.

FIG. 5 is a flow chart of reviewing plans of contacts via Social Planning.

FIG. 6 is a flow chart of presenting events via Social Planning.

FIG. 7 is a flow chart of integrating data sources via Social Planning.

FIG. 8 is a flow chart of mining data collected via Social Planning.

FIG. 9A illustrates a first portion of an exemplary user interface for aspects of Social Planning.

FIG. 9B illustrates a second portion of an exemplary user interface for aspects of Social Planning.

FIG. 9C illustrates a third portion of an exemplary user interface for aspects of Social Planning.

### DETAILED DESCRIPTION

### Context of Social Planning

### Overview of Social Planning

As stated above, planning is the marshalling of resources and people and/or entities. Where the plan relates to a common experience, that common experience is called an event, and the associated planning is called event planning. People and/or entities that are to participate in the event are called invitees.

Events generally are associated with location/venue and date/time data for the event. Plans comprise plan data that generally includes an event identifier and/or event data, and a plurality of persons and/or entities who are participating in, might be participating in, or have been invited to that event. The plan data may include pending and/or contingent participation by a person. For example, an invitation to a person may be pending. Alternatively, a person may reply with a “Maybe” indicating that the person's participation in the event may be cancelled thereby changing the person's relevance to planning. Potentially, the person's participation may be confirmed later or left indeterminate indefinitely.

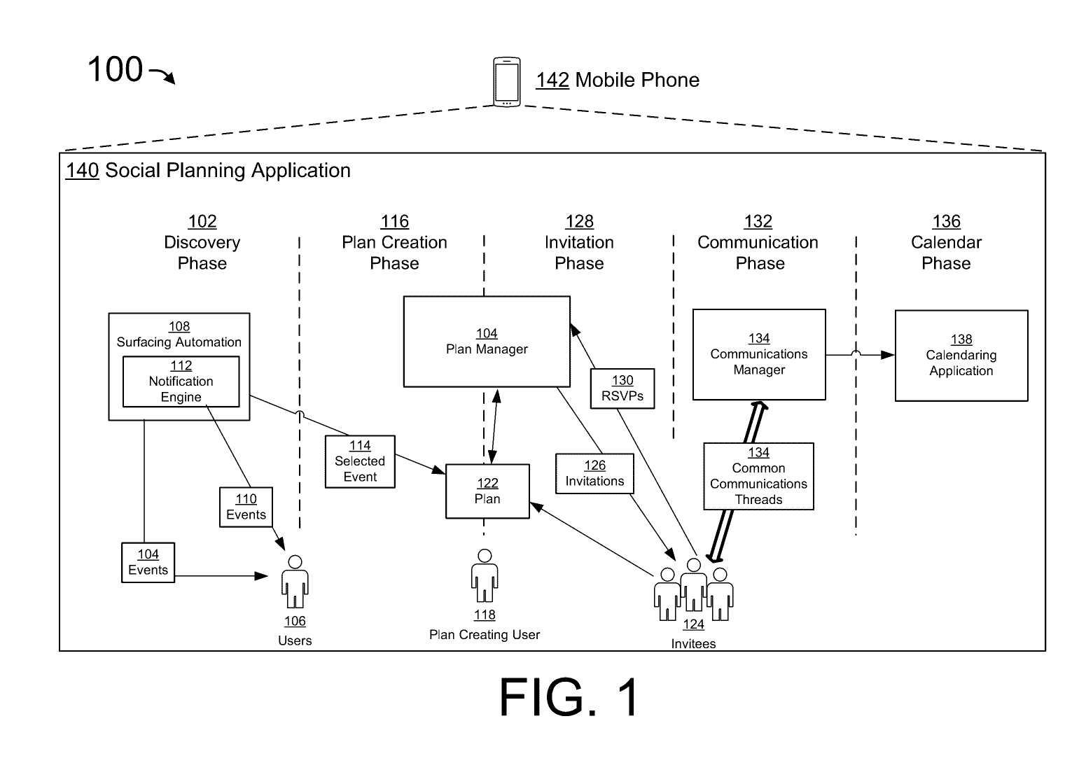

In of itself, the complexity of event planning suggests automation. However, despite the present proliferation of planning tools, each planning tool performs only a portion of the planning process, often in isolation from each other. Accordingly, techniques to implement Social Planning is described herein. Social Planning is not merely the addition of community to planning, or merely the addition of a social network that a person is participating in to the planning process. While Social Planning may include Web 2.0 features such as user generated content, usability models, and interoperability, such as with a social network, Social Planning as described herein, is a set of specific bindings, and application behaviors thereby enabled, to support specific Social Planning use cases. These Social Planning use cases are introduced below with respect to the context diagram of FIG. 1.

### Overview of Social Planning

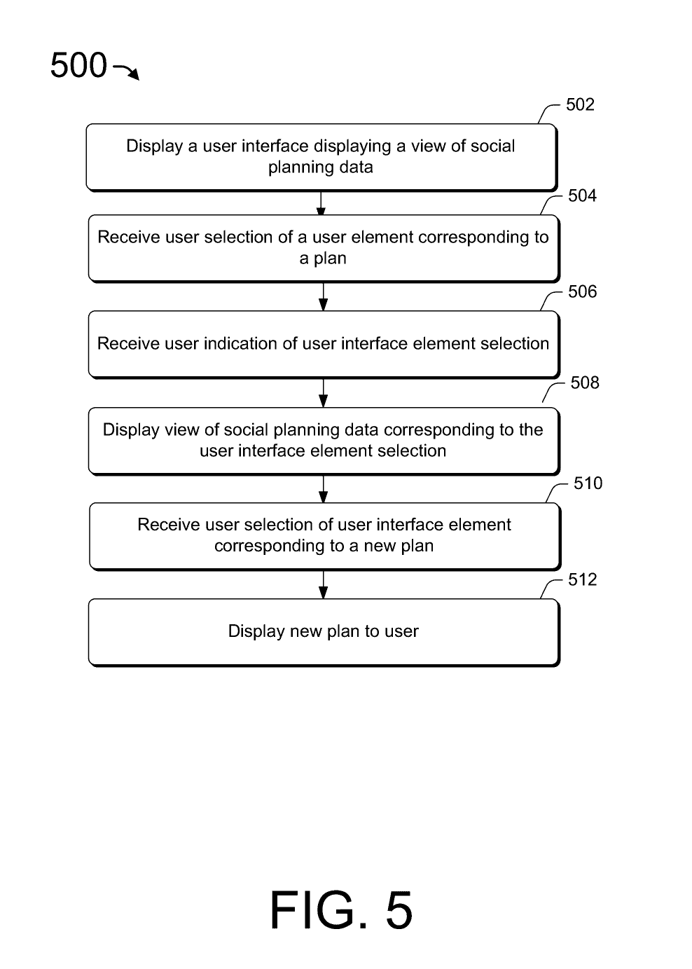

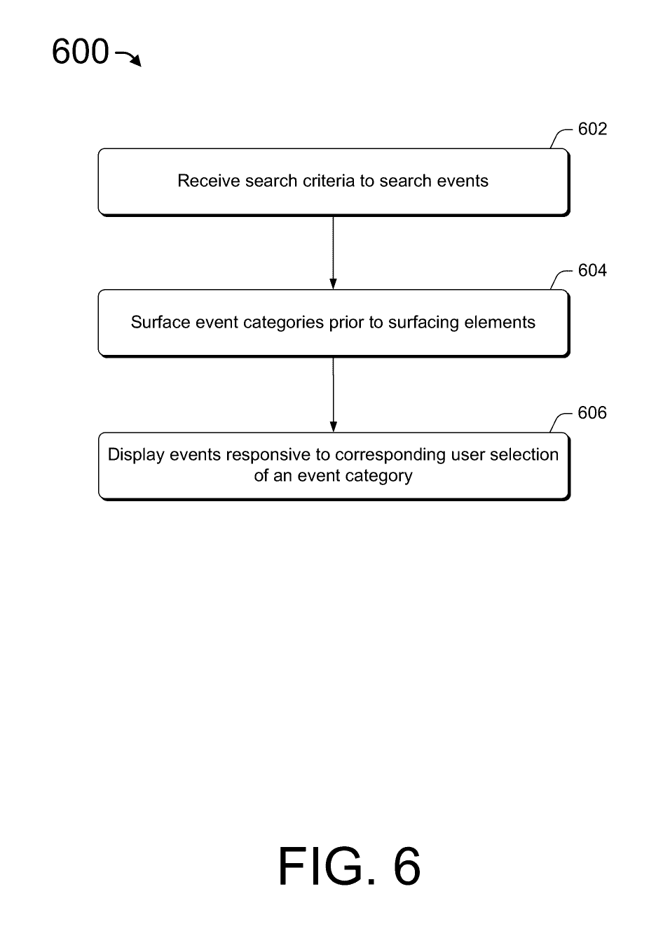

Social Planning may be understood in the following framework as illustrated in the context diagram 100. Events may first be discovered during a discovery phase 102. During the discovery phase 102 events 104 may be presented to users 106 via surfacing automation 108. Note that “surfacing” is the general computer science term to “present” or to “bring to the user's attention.” Alternatively, events 110 may be pushed to users 106 via notifications from a notification engine 112. Discovery/event presenting use cases are described in greater detail with respect to FIGS. 5 and 6.

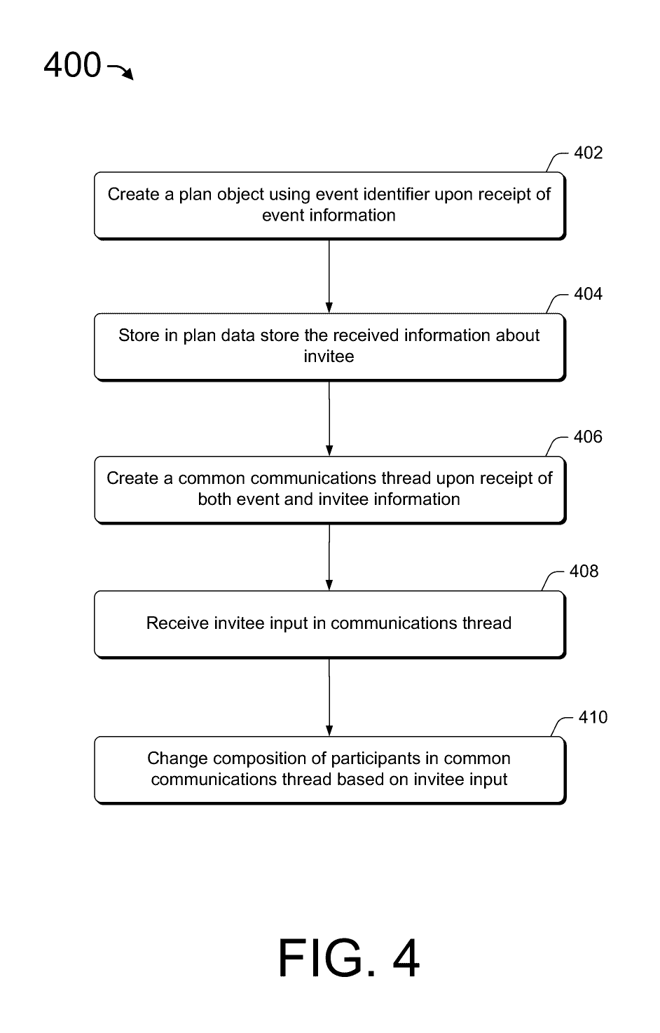

Once events are discovered, a particular event may be selected 114 a plan may be created in the plan creation phase 116. A plan creating user 118, may use a plan manager 120 to create a plan 122, that is to say the combination of the selected event 114 and one or more invitees 124 indicating participation in the selected event 114. Generally a created plan 122 is associated to the plan creating user 118. Plan creation use cases are described in greater detail with respect to FIG. 4.

In order to obtain indications that invitees 124 are participating or may be participating in an event, typically invitations 126 are sent to those invitees 124 during an invitation phase 128. Invitations 126 are generally sent and RSVPs 130 are generally received via one or multiple communications channels 130. Invitation use cases are also described in greater detail also with respect to FIG. 4.

As described above, event planning is complicated by the organic nature of human schedules. Persons may commit to participation, but may back out. Furthermore, a person's online participation status may be set to commit or not commit, but the person in fact may do the opposite. Accordingly, during a communications phase 132, various communications threads may be initiated by the plan creating user 118 and the invitees 124 via a communications manager 134. Generally, the communications threads may be over different channels, and may potentially be mixed and/or combined with non-planning related communications. Communications use cases are also described in greater detail with respect to FIG. 4

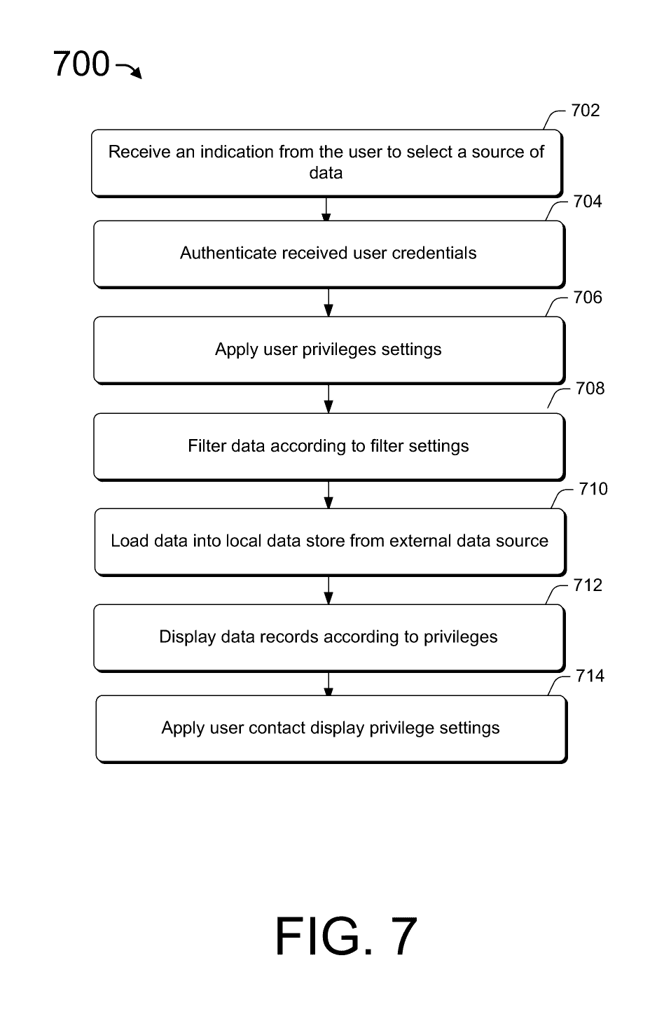

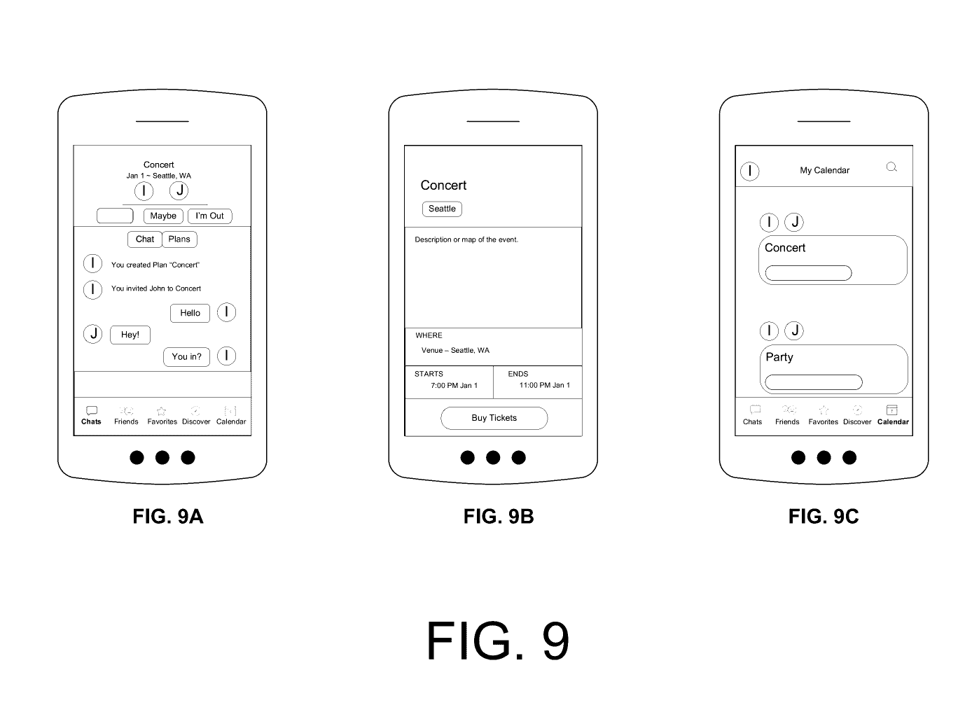

Invitees 124 may make use of additional information to determine whether to commit to a selected event 114. The persistence of the decision is called the calendaring phase 136. It is to be emphasized that the decision to participate in an event is organic and subject to change at any time. Persistence may be performed in a number of applications, including by a calendaring application 138. Calendaring use cases are described in greater detail with respect to FIGS. 7 and 9C.

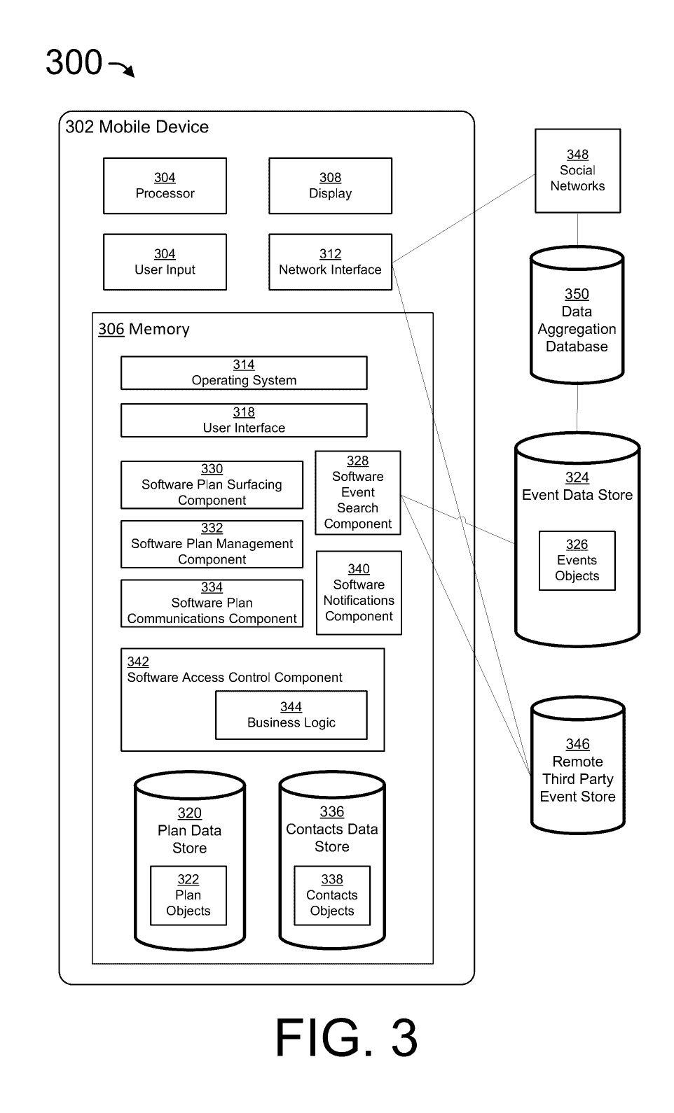

As previously mentioned, Social Planning is not the mere addition of social network data, or of Web 2.0 techniques, but rather a series of specific integrations to optimize, and make more collaborative the planning process. Accordingly, herein are disclosed specific integrations for all planning phases, where a single social planning application 140 comprises at least some of the functionality with respect to surfacing automation 108, plan manager 120, communications manager 134 and calendaring application 138, where this functionality is integrated. The architecture of such a social planning application 140 is described in greater detail with respect to FIG. 3.

### Context of Mobile Applications

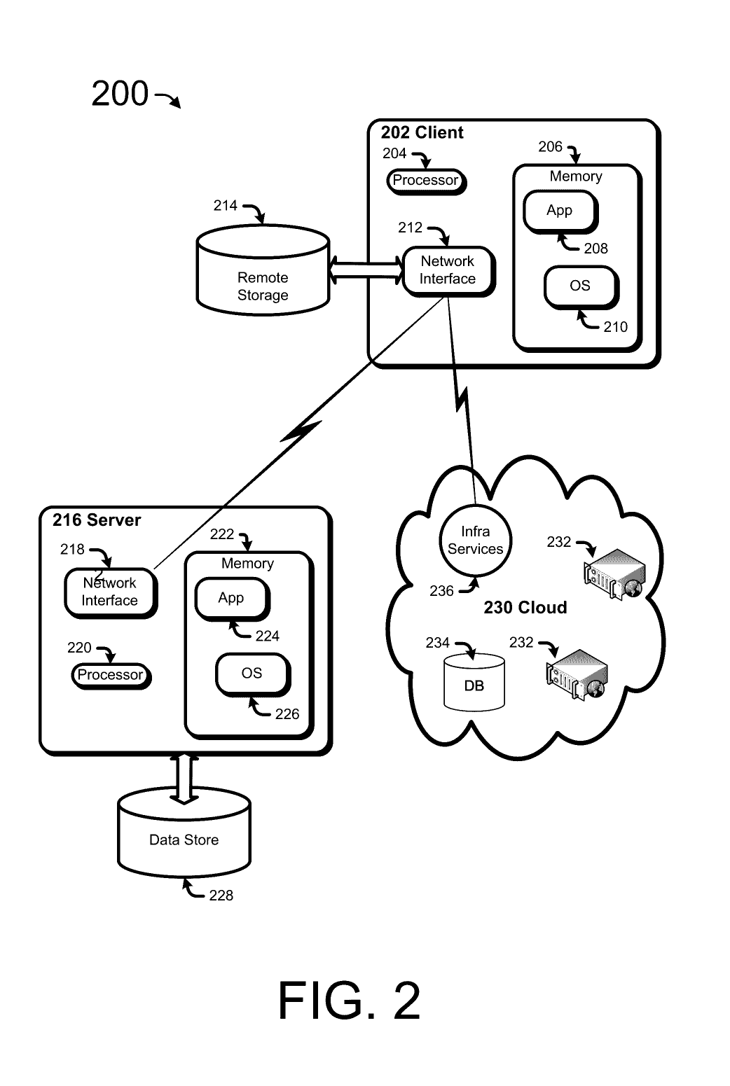

The social planning application 140 may be hosted on a mobile device 142. Mobile devices are described in greater detail with respect to FIG. 2. A mobile devices 142 gives rise to capabilities not necessarily available on standalone computers. Specifically, because a mobile device 142 is constantly with a plan creating user 118 or an invitee 124, communications may be more interactive and nearer to real time. However, because a mobile device 142 has a smaller form factor, a mobile device 142 gives rise to user interface features to reduce user inputs and to make efficient use of display space. Mobile user interface features are described in further detail with respect to FIGS. 9A, 9B and 9C.

### Data Aggregation

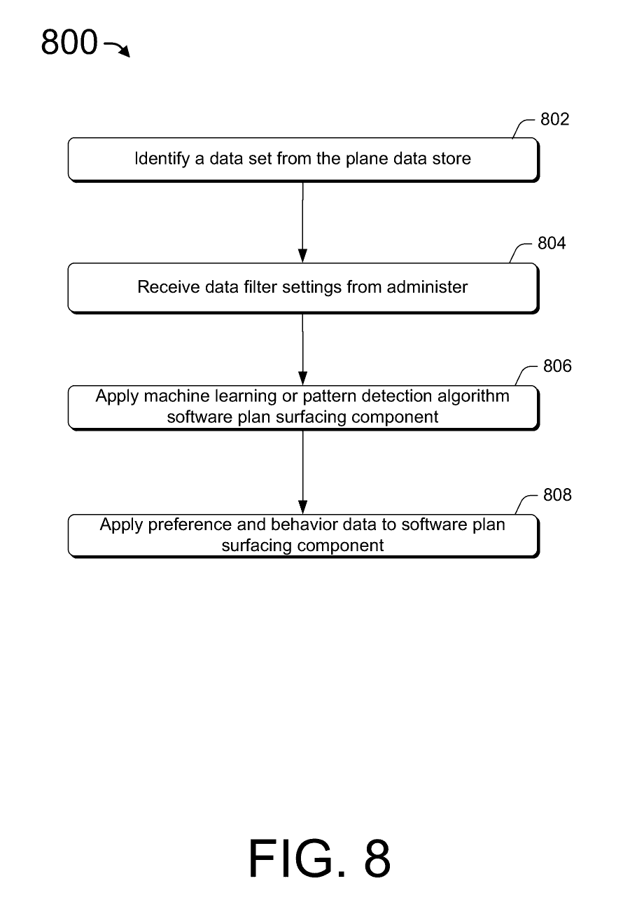

An advantage of developing an extended platform to perform social planning includes aggregating social planning interactions and performing data mining. Specifically, where a social planning application owns references to all communications related to a person committing to an event or considering participating in an event, those communications and interactions with a social planning application 140 may be stored and aggregated on a social planning data store such as plan data store 320, which is described in greater detail with respect to FIG. 3. Accordingly, this data may be mined to enable directed marketing and other directed operations to users 106 with a high degree of accuracy. Because a user operation on the social planning application 140 is often not merely an indication of interest, but an indication of an actual affirmative course of action, social planning data is more indicative of interests of those users. Data mining of social planning data is described in more detail with respect to FIG. 8.

### Exemplary Hardware, Software and Communications Environment

### Computing Device

Prior to disclosing Social Planning, an exemplary hardware, software and communications environment is disclosed. FIG. 2 illustrates several possible embodiments of a hardware, software and communications environment 200 for Social Planning and related techniques.

Client device 202 is any computing device. Exemplary computing devices include without limitation personal computers, tablet computers, smart phones, and smart televisions and/or media players.

A client device 202 may have a processor 204 and a memory 206. Client device's 202 memory 206 is any computer-readable media which may store several software components including an application 208 and/or an operating system 210. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment, client device 202 may have a network interface 212. The network interface 212 may be one or more network interfaces including Ethernet, Wi-Fi, or any number of other physical and data link standard interfaces. In the case where the user need only do operations on a standalone single machine, the network interface 212 is optional.

### Client-Server/Multi-Tier

Client device 202 may communicate to a server 216. Server 216 is any computing device that may participate in a network. The network may be, without limitation, a local area network (“LAN”), a virtual private network (“VPN”), a cellular network, or the Internet. The client network interface 212 may ultimately connect to remote networked storage 214, or to server 216 via server network interface 218. Server network interface 218 may be one or more network interfaces as described with respect to client network interface 212.

Server 216 also has a processor 220 and memory 222. As per the preceding discussion regarding client device 202, memory 222 is any computer-readable media including both computer storage media and communication media.

In particular, memory 222 stores software which may include an application 224 and/or an operating system 226. Memory 222 may also store applications 224 that may include without limitation, an application server and a database management system. In this way, client device 202 may be configured with an application server and data management system to support a multi-tier configuration.

Server 216 may include a data store 228 accessed by the data management system. The data store 228 may be configured as a relational database, an object-oriented database, a NoSQL database, and/or a columnar database, or any configuration to support scalable persistence.

### Cloud

The server 216 need not be on site or operated by the client enterprise. The server 216 may be hosted in the Internet on a cloud installation 230. The cloud installation 230 may represent a plurality of disaggregated servers which provide virtual web application server 232 functionality and virtual database 234 functionality. Cloud services 230, 232, and 234 may be made accessible via cloud infrastructure 236. Cloud infrastructure 236 not only provides access to cloud services 232 and 234 but also billing services. Cloud infrastructure 236 may provide additional service abstractions such as Platform as a Service (“PAAS”), Infrastructure as a Service (“IAAS”), and Software as a Service (“SAAS”).

### Exemplary Architecture for Social Planning

### Architectural Overview

FIG. 3 is an architectural diagram 300 of the social planning application 140 and related items. It provides a specific description of how the environment as described with respect to FIG. 2, is configured to perform Social Planning.

### Social Planning Application

As described with respect to FIG. 2, a mobile device 302 comprises a processor 304, memory 306, display 308, user input 310, and network interface 312. Resident in the memory 306 is an operating system 314 and the social planning application 140.

The social planning application 140 comprises a number of software components including a user interface 318. The user interface contains specific user interface elements to facilitate Social Planning use cases on a small form factor. Those Social Planning use cases are described in greater detail with respect to FIGS. 4, 5, 6 and 7. The specific user interface elements are described in greater detail with respect to FIGS. 9A, 9B and 9C.

The social planning application 140 includes a plan data store 320. A plan data store 320 is a database of plan objects 322, each plan object linking event information and a plurality of persons who are participating in, might be participating in, or have been invited to the event. The database may be implemented by any of the database management systems set forth with respect to FIG. 2. A plan object 322 may store event information within the plan object 322 itself, or alternatively may simply store an event identifier that provides a reference to the event. Similarly, a plan object 322 may store information of the persons and/or entities participating in the event or just an identifier that provides a reference to the respective person and/or entity. Since a person's and/or entity's plans may evolve over time, the plan object 322 may store an indication or a reference indicating whether the person and/or entity is attending, is not attending, or may be attending.

A plan object 322 may reference other plan objects 322 thereby enabling the nesting of plan objects 322. This structure recognizes that a plan may be comprised of a plurality of subplans, each subplan constituting a plan unto itself, and therefore having its own plan object. For example, a user may plan to go on a trip, comprising both a personal event and a public conference. The trip, the personal event, and the public conference may each be persisted in their own plan object 322 where the trip references both the personal event and the public conference as subplans. Because the different sets of users may be interested in the personal event as opposed to the public conference, storing those subplans as separate plan objects 322, those plan objects may be presented separately thereby enabling a higher degree of fidelity in presenting the plan through a user interface or otherwise.

The social planning application 140 may access an event data store 324. An event data store 324 is a database of event objects 326, each event object 326 storing event information which may include without limitation an event identifier, event name, event category, event sub-categories, city/neighborhood where located, venue, start date/time, end date/time, and/or associated events. An event category is an entity that is a source of events such as sport teams, music artists, and performers.

The event data store 324 may be, but need not be, local or incorporated into the social planning application 140. The social planning application 140 accesses the event data store 324 via a software event search component 328, via a communications connection. The event data store 324 may be a remote database, potentially with third party data feeds populating the event data store 324. The event data store 324 may be curated. The event data store 324 may be linked to other data stores persisting user generated content. Common forms of user generated comment may be comments/notes about event objects, rankings, reviews, links related to the event and/or uniform resource locators, and social network links.

In the case of a relational database, the event identifier may be an artificially generated primary key. Accordingly, an event identifier may be distinct from the event name. However, in some embodiments, where an event name is known to be unique, the event name may serve as an event identifier.

An event category may indicate a term or phrase that allows a set of event objects 326 to be grouped together based on a common interest. Example event categories include sports teams, performers, and interest groups. By selecting event objects 326 with an event category in common, and sorting by event start date/time, the software event search component 328 may retrieve a schedule of events for that event category.

The city/neighborhood provides a geolocation for the event, thereby enabling the software event search component 328 to search for event objects 326 by proximity.

A plan object 322 is created, either by creating an event, or by retrieving one or more event objects 326 via the software event search component 328. In the latter case of the, a software plan surfacing component 330, part of the social planning application 140, may present those retrieved events. The software plan surfacing component 330 receives criteria from a user and based on that criteria retrieves event objects 326 from the event data store 324 using the software event search component 328. Alternatively, the software plan surfacing component 330 receives criteria from a user or from an automated source, such as a store of behaviors and preferences, and based on that criteria retrieves plan objects 322 from the plan data store. Because event information is either embedded or referenced in the plan objects 322, searches of events embedded in plans are also enabled. Where plan object 322 is presented to a user, the user may opt in to the plan object 322 thereby indicating participation in the event referenced by the plan object 322. The software plan surfacing component 330 is analogous to surfacing automation 108, except that it generally will make of information available to social planning application 140 to determine which event objects, and subsequently which plans to present.

The social planning application 140 includes a software plan management component 332 that enables the creation, updating and/or deleting of plan objects 322. The software plan surfacing component 330 may retrieve plan objects 322 to the user, and the user may make new plans objects, based on existing events or alternatively creating new event for a plan object 322. The user may also update existing plan objects 322 by adding, modifying or deleting event information, or by adding, modifying or deleting participation information. The user may also delete existing plan objects 322. Accordingly, the software plan management component 332 is analogous to a plan manager 120, except that it generally will make of information available to social planning application 140 also available to the user as the user browses plan objects 322.

One feature of Social Planning is the integration of the communications threads documenting the thinking, considerations and planning details of event participants and potential event participants during planning. Accordingly, the social planning application 140 includes a software communications component 334. The software communications component 334 manages multiple communications threads through a plurality of communications mediums. One or more plan objects 322 may be referenced in a communications thread, thereby allowing the thinking surrounding planning to be quickly accessed. The software communications component 334 is analogous to a communications manager 134 except that generally multiple communications threads are referenced together into a single common communications thread, and that references to plan objects 322 are linked to the single common communications thread.

The single common communications thread may be configured to utilize interactive communications mediums. Specifically, an interactive communications medium is a medium designed to route messages and to accommodate responses to those messages. Where a non-interactive communications medium, such as posting, comprises messages sent to and/or viewable by a group, but not necessarily to receive responses, interactive communications mediums are designed to accommodate conversations, where responses to messages are anticipated. Common interactive mediums may include without limitation chat/internet messaging, short messaging system, voice communications, electronic mail and other mediums of digital communications.

The social planning application 140 may include a contacts data store 336 containing contacts objects 338 storing information about other persons or entities that may be interested in a user's plans. A contacts object 338 may store a contact identifier, a contact name, and a communications address for the contact. The communications address may be a reference to that user or that entity's account for their corresponding social planning application 140. (Note that in the context of social networks, contacts are sometimes called “friends.” The contacts data store 336 may be local or remote. The contacts data store 336 may be populated or supplemented by accessing a user's phone/mobile device contacts and/or social networks the user is participating in.

The social planning application 140 includes a software notifications component 340 that may send notifications to a user's contacts. Notifications provide a mechanism to keep event participants or potential participants abreast of planning changes in near real time. Notifications may have one of several sources. Notifications may come from one of the software components of the social planning application 140 or associated systems as described below. Notifications may be triggered by an event planner, such as when changing event details. Notifications may be triggered by a partner, usually the performer or subject of an event. Notifications may be triggered by invitees, such as in changing their participation status. The software plan management component 332 may send notifications via the software communications component 334, to one or more contact objects 338 that a plan has been created, updated or deleted. Alternatively, as the single common communications thread progresses, the software communications component 334 may send notifications of changes in the communications thread, such as the addition or deletion of participants in the communications thread.

In some cases, the capability to create, retrieve, update or delete plans and/or events, or to have access to communications threads may be limited to some users. Specifically, the social planning application 140 includes a software access control component 342. The software access control component 342 provides access control to capabilities and communications in the social planning application 140 in terms of social planning privileges. Where a standard access control for a file system includes access control for file read, write and execute privileges, the software access control component 342 provides privileges to create, retrieve, update and/or delete a user's plans or degrees of participation in a communications thread. Access control therefore attaches to a set of privileges around who can edit events, who can change the set of individuals invited to an event, who can create sub-plans, who can participate in communications threads around the event, and/or who can delegate rights. Accordingly, privileges around an event are on a per person/event basis with a very granular degree of control. In this way, event planning may be made private to a limited set of contacts, and the integrity of the planning process may be trusted since privileges are limited only to a set of trusted contacts.

The decision to participate in a plan involves determining whether there are constraints and/or planning conflicts. The social planning application 140 includes business logic 344 to detect those constraints and/or conflicts. An example of such business logic 344 is calendaring application 138. However, the social planning application's business logic is integrated to present those constraints and/or conflicts to the software plan management component 332 and other portions of the social planning application 140. The business logic 344 may import calendar information on the local phone/mobile device and/or third party applications including social networks the user is participating in. In this way, the social planning application 140 may whether events overlap, and where events are proximate in time, location, or both.

Remote and/or Third Party Related Items

As described above, the social planning application 140 integrates much functionality in the planning process. However, this integration does not preclude extensibility and interoperability of the social planning application 140. Rather, much of the integration is enabled via the linking of information. For example, the social planning application 140 may communicate with a proprietary event data store 324, or alternatively with a remote third party event store 346, separately curated and/or managed.

As described above, the social planning application 140 may communicate and/or interface with one or more social networks 348 that the user is participating in. Common integration may include accessing not only contact information and calendaring information, but also receiving indications of what preferences (“likes” in social networking parlance), a user has, in order to inform plan/event presentation.

In general, the social planning application 140 may integrate with a third party application that exposes user profile, contact/friend, event and other data. Third party applications may be social networks 348 the user participates in, but may also be desktop and mobile applications. The social planning application 140 will generally make use of application programming interfaces exposed by the third party application. There generally will be an authentication step allowing access to the application programming interfaces, and a way to enumerate data. For example, the social planning application 140 may query a third party application for the user's preferences as stored in the user's profile. Those preferences may then be used to influence queries such as the software event search component 328.

Plan objects 322 and communications threads associated with those plan objects may be aggregated and stored in a data aggregation database 350. The data aggregation database 350 may be mined for user behavior and preference patterns. Behavior and preference information may then be used to change the likelihood that event objects 326 are presented by a social planning application's software plan surfacing component 330.

### Use Cases

### Overview of Use Cases

By providing the integration of various planning components into the social planning application 140, many Social Planning use cases are enabled. FIGS. 4, 5, 6 and 7 respectively describe integration of communications threads with planning, reviewing plans of contacts for potential opt in, presenting events, and integrated calendaring. Furthermore, the plan data may be aggregated and mined. Data aggregation is described with respect to FIG. 8.

Communications Threads Integrated with Planning

Where past planning automation separated the communications portion of planning from plan information, Social Planning integrates the two. Specifically, plan information is anchored to communications, often in a single common communications thread. Where in the past, communications with different users might be in different communications threads and media, the social planning application 140 creates a single common communications thread as part of the plan creation process.

The notion of a single common communications thread relates to ensuring that the communications thread can be efficiently gleaned for information of interest. One aspect of the present disclosure is that communications threads may later be aggregated or mined for information. The anchoring of the communications thread to a plan, and the tracking of the communications thread with respect to the planning process enables more efficient selection of data of interest.

The communications thread is preferably a single communications thread such that all or a substantial portion of data in thread is known to be related at least to the plan it is anchored to. While an application cannot enforce that one form and one thread of communication be used by planners and invitees, the aspect of having a single thread with all the information relating to a plan and/or event proximate can encourage the majority of communications relating to the plan and/or event be via the single communications thread.

The communications between invitees should be interactive, rather than non-interactive. A communications thread is not merely a presentation of communications where different communications postings are proximate to each other on the same user interface. Here a communications thread is a continuous interactive communications within a prescribed set of individuals. Non-interactive communications, such as postings, are communications to a group where a response proximate in time or any response is not expected. Interactive communications, such as chat, are as described above, communications where response is expected to be proximate.

Interactive communications are helpful to subdivide a communications thread. Note that in the social planning application 140, a plan via a plan object is associated with a single common communications thread. Accordingly, the single common communications thread is likely to have several topics discussed in the same thread. For example, a single common communications thread may have an initial topic about: (1) introducing a birthday party, then (2) what presents to bring, and finally (3) what venue to meet at. A communications medium that is interactive supports conversational interaction thus related messages are likelier to be proximate in time and therefore proximate in a presented thread where messages are ordered chronologically. The expectation is that a review of this example communications thread will result in three clusters, one around the birthday party, a second around presents, and a third around venue.

Note that the clustering of data will not be perfect. It is expected that different topics in the thread will have messages interwoven each other. Discussion is expected to organically transition between each of the topics. Furthermore, comments not relevant to the topic and indeed not relevant to the event may be made. However, the result is that proximate data have an increased likelihood to be contextually relevant. That is to say that one piece of data near another piece of data are more likely to be related to the same topic.

This grouping or clustering property has positive effects on users. Data from around communications made in interactive communications tend to be more contextually related than postings in non-interactive communications. Where postings to a web page can resemble an undifferentiated bulletin board, interactive communications tend to have contextually related information more proximate to each other. Thus users sense that the user experience is more coherent and cohesive.

This grouping or clustering property also has positive effects on data mining Data mining a single common communications thread that is anchored to a plan lets a data mining algorithm determine that data in the thread is likely related to the event in the linked plan. However, grouping or clustering allows for another level of fidelity. Because the data in the communications thread is interactive, the data is more likely to cluster around topics. This aids the computational detection of those topics around those clusters.

A feature to encourage use of a single common communications thread is the addition of all notifications added by time to the single common communications thread. Notifications include notifications triggered by all sources; notification from the system, from the plan author, from invitees, and from partners (such as performers or other sources of events) are in the single common communications thread. These notifications are inlined by time with the sequence of communications among invitees and between invitees and other parties. It is expected that a notification may spawn additional communications by invitees in response to the notifications. Accordingly, subsequent data mining can check for communications proximate to events for relevant data.

Indeed, having a single common communications thread where the communications is interactive has benefits for the user. Not only is a user presented with and can easily access a single thread, the user can expect communications proximate to each other to be more related than non-interactive postings. Accordingly, the user will come to expect to seek the single common communications thread for relevant information to the event. Thus the features aiding subsequent data mining also aids the user.

The single common communications thread itself should be proximate not only to a view of the event data, but also to views of different contexts of the event. A discussion of toggling views is with respect to FIGS. 9A, 9B and 9C below.

From a data mining perspective, another factor to encourage that the data in a single common communications thread be as relevant to the plan and/or event, is to specify what interactions and the participants in a single common communications thread can be made on a per user per privilege basis. Where other communications systems simply determine whether a participant in a communications thread can view a thread or add to a thread, the single common communication thread disclosed herein can control interactions on a per user per privilege per thread basis. The effect is to make more data in the single common communications thread more relevant for data mining by limiting participants able to add to the thread to those most likely to give high quality/high relevance input.

Specifically, when a single common communications thread is created, a plan author and the invitees constitute a set of users that might interact in the single communications thread. The plan author or an administrator can set granular privileges to other participants; whether they can view, participate, add additional users and/or invitees, and/or make breakouts are on a per user basis.

The notion of breaking out of the single common communications thread comes in the form of making a subplan, which is a plan comprised of a matching or subset of invitees to make a side event related to the event in the plan. A subplan may or may not have the effect of creating a new communications thread related to the side event. From a data mining perspective, this adds information that help further organize data in communications threads. Specifically, the plan object for the parent plan has a single common communications thread with participants taken from the larger parent plan, but the plan object for the subplan has its own common communications thread with participants limited to that of the subplan. Accordingly, users will find data in the respective threads to be more relevant providing a more cohesive and coherent experience. Data mining applications will be able to more easily determine relevance become communications for the subplan are broken out from the parent plan.

In summary, anchoring a communications thread to a plan is designed in such a way to make it more likely that proximate communications are related to each other. In this way, finding data more likely to be relevant is easier both for the user and for data mining. Thus the communications thread is cannot merely be an undifferentiated thread. The communications thread is a single common thread. Communications are interactive to elicit faster responses resulting often in more coherent communications. Event and contextual data are kept proximate to the single common communications thread. Not only the participants, but the degree of participation can be managed granularly. Accordingly, the single common communications thread achieves what both user and data miner desire, more relevant information that is easier to find. While an application cannot enforce relevance of data in the communications thread, the application is configured to make the addition of relevant data significantly more likely.

FIG. 4 is a flow chart 400 of the plan creation process. In block 402, the software plan management component 332, receives event information from a user that is a plan author or alternatively is selected by the plan author from other event sources, and creates a plan object 322 using the event identifier. The plan object is then stored in the plan data store 320. The event information may be an event identifier from a pre-existing event, such as stored as an event object 326 in an event data store 324. Alternatively, the software plan management component 332 may receive new event information directly from the user and create a plan object 322 accordingly.

In block 404, the software plan management component 332 receives information about one or more invitees to the event and stores this information in the plan object 322. The invitee information may be references to existing contact information, such as in a contacts data store 336. Note that invitee information external to contacts data store 336 may be associated with an event. One example is when an invitee adds additional invitees from their own contacts, which may not have records in the plan author's contact data store 336.

Upon receiving both event and invitee information, in block 406, the software communications component 334 creates a single common communications thread, and links the single common communications thread to the plan object 322. The single common communications thread may be a group chat via an internet messaging application, or by way of another example may be a group short message service session. The single common communications thread may be via any communications medium integrated into the social planning application 140. As the single common communications thread is integrated with the social planning application 140, note that the social planning application may be “white-labeled”, that is rebranded by a partner. For example, the social planning application 140 may be branded by a sports team or performer.

After creation of the plan object 322, optionally the plan author may set privileges for invitees via the software access control component 342. The plan author may add, modify or delete privileges for one or more invitees to correspondingly add, modify or delete plan information or to participate in the common communications thread. Alternatively, the plan author may add, modify or delete the ability for non-invitees to access the plan object 322 or otherwise add, modify or delete plan information. For example, the software plan surfacing component 330 would be prevented from presenting plans marked as private.

During the course of the single common communications thread, in block 408 one more of the invitees may provide some input to the single common communications thread. Input may be addition of third party information such as an internet link, a link to third party application such as a social network, and/or a link to any type of information relating to the plan and/or event. Based on the input, the software notifications component 340 may be configured to send a notification to invitees or others that such a link has been made. In this way, activity on other third party platforms, such as social networks, may be incorporated into the single common communications thread.

Examples of third party data integrations and/or incorporations may include Facebook™ “Likes”, Facebook™ Events, Facebook™ profile information, present locations, future locations and plans, Spotify™ music artist interests, Twitter™ followers, calendar events, and plans captured via TripIt™.

Cognizant that a person's intent to participate in an event is fluid, in block 412, the software communications component can change the composition of participants in the single common communications thread based on input from the plan author and/or invitees. Specifically, the software plan management component 332 may receive an indication that an invitee is confirming, being added, or being removed, or otherwise an indication of their participation status changing. Upon receiving this indication, the software communications component may change the composition of participants in the single common communications thread and optionally may send a notification to one or more of the plan author and/or invitees, or others. Where an invitee is being removed, the invitee may be removed from the common communications thread, and from subscription to notifications relating to the plan object 322. Where an invitee is added, the invitee, at the option of the plan author or an administrator, may view the common communications thread in full, or starting at the time the invitee was added.

### Reviewing Plans of Contacts

In Social Planning, persons have the ability to view not only their plans, but also to review the plans of their contacts. As described above, contacts may be personal and/or business relationships of varying degrees. Contacts may be close personal friends, family members, work colleagues, and/or acquaintances.

In Social Planning, contacts are identified by reviewing electronic collections of contact information of individuals. These collections may include the phone book or contact book on a mobile device, the list of friends on a social network, an electronic mail address book, or other collection of electronic information where a person may store contact information.

The social planning application 140, may leverage this information via contacts data store 336. Specifically, via the social planning application 140, persons can see what plans their contacts are participating in, and may decide to participate as well. Specifically, one factor that may affect a person's decision to participate in an event is in discovering that other people they know are participating in that event.

Two ways for a person to participate in an event for a contact are: (1) to create the person's own plan to participate in an event that a contact happens to be participating in, and (2) to participate in the contact's plan by requesting the plan author and/or the contact to become an invitee in the contact's plan object.

In the former case, the person may make a plan as described with respect to FIG. 4. In the latter, case, the person may indicate a desire to participate in the contact's plan. For example if a user is viewing an event, the software plan management component 330 in conjunction with the plan data store 320 and the contacts data store 336 that a contact of the user has a plan to participate in that same event. The user may be shown a user interface showing plans of the contact, and if the user selects a plan of interest, the software communications component 334 may make a notification via the single common communications thread associated with the plan stating an interest of the person to not only participate in the event, but also to participate in the plan. At that point the contact (or the plan author, depending on privileges set), may allow the person to join the plan.

The foregoing examples illustrate the difference between participating in an event, and participating in a plan. In the former example, the person is merely scheduling by creating a personal plan to go to an event. In the latter example, the person is requesting participating in the planning process, and the single communications thread with others participating in the plan. In the latter example, the person gains visibility to the thinking of all the invitees for that particular plan, and can make personal planning decisions accordingly. If the event were a concert, instead of seeing postings from 50,000 participants, the person will see perhaps messages from the five people attending, going and/or potentially going the concert that the person cares about.

Regardless if the person schedules their own plan or seeks to participate in a contact's plan, FIG. 5 provides a flow chart 500 of an exemplary process to review the plans of contacts and/or to opt in plans of contacts.

In block 502, the social planning application 140 displays a user interface displaying one of a plurality of views of social planning data. A first view may show a view of existing communications threads for existing plans that the user is an invitee or a plan author. A second view may be a calendar view displaying at least plan data. A third view may be a view of event data underlying a plan. The views provide user interface elements by which the user may select a plan displayed by the view. Various views are described in further detail with respect to FIGS. 9A, 9B and 9C.

In block 504, the user selects a user element corresponding to a plan on the currently displayed view. The social planning application 140 has a user interface component tracking the selected user element.

In block 506, the user indicates via a user interface element, a selection of a different view for the social planning application 140 to display. Responsive to the selection of a different view, in block 508, the user interface displays the view of social planning data corresponding to the selection, based on at least the selection of a plan in block 504. For example, in a calendar view, the date range selected for display corresponds to the date of the event corresponding to the selected plan. In a chat view, the communications thread displayed is the single common communications thread associated with the selected plan. In an event view, the underlying event data displayed is that of the selected plan. In this way, the different views anchor and integrate the underlying data to facilitate Social Planning.

Since a view may potentially have a large number of plans to display, a view may be subjected to a filter. Filters may be of a user's and/or contacts plans. Other filters may be of particular criteria to display. Criteria may include location and/or event category.

In one embodiment, one filter may be of active/upcoming and past plans. Active/upcoming plans are plans where the underlying event has not yet occurred or completed. Past plans are where the underlying event has been completed. Users may desire to keep data of past plans, since the plans are anchored to communications threads. For example, a user may seek to make a new plan leveraging a past plan. Leveraging a past plan may be where a portion of the data associated with the past plan becomes copied, attached or otherwise associated with a newly created plan. One user interface element to apply a filter may be a toggle user interface element, or a button user interface element to select whether to show active plans or past plans. Alternatively, active/upcoming plans and past plans may be shown in different folder user interface elements.

In one embodiment, additional events and/or plans of friends are shown in the views. In this way, a user may see what plans a user's contacts are participating or may be participating in. A filter may be applied to select which contacts' plans to show. Alternatively, a filter may be applied which shows plans that are proximate in location, proximate in time, or both. In this way, contacts that are not generally proximate to a user may have their plans surfaced when they happen to be proximate. One user interface element to apply a filter may be a toggle user interface element, or a button user interface element to select whether to show all plans, or just plans proximate in time, proximate in location, or both to the user. Furthermore, the user interface elements corresponding to plans may be color coded by proximity in time, proximity in location, proximity of both time and location, and/or identity of the contact or contacts participating or may be participating in the plan.

A user may therefore review their plans in the context of the plans of contacts in their Social Planning networks. In block 510, a user may then select a user interface element corresponding to a plan that the user is not yet participating in. In block 512, the plan is displayed to the user, and the user may then select a user interface element, such as a button, to indicate that the user wishes to participate in the plan. In this case, a request for an invitation to participate in the event is sent, and the plan author may allow an invitation to be sent, or for the user to participating in the plan author's plan as described above, depending on privileges. Otherwise, in the case where a user is opting in to a public event, that one of the user's contacts happens to be participating in, the user may simply make a separate personal plan to participate in the public event.

### Surfacing (Presenting) Events

Thus far, plans have either been authored or presented, that is to say brought to the attention of a user, where someone else, such as a contact has authored a plan. However sometimes, a user will simply discover an event on his or her own. Part of the benefit of social use cases is to make use of information about a user to identify items of interest to that user. Social planning may make use of profile information and/or behavioral data of a user. Here, the social planning application 140 may also make use of the plan authoring process as well. FIG. 6, provides a flow chart 600, illustrating an exemplary process.

In block 602, the social planning application 140 receives search criteria to search events. The search criteria is to be used by the software event search component 328 to search for events matching the criteria. However, while prior art searches generally have a user enter search terms, the social planning application 140 may create/generate search terms dynamically, transparent to the user, which are then used to search for events via the software event search component 328.

One example of dynamically generated search criteria, is to use the plan name. When a user starts to create a plan, one input is the entering of a plan name. As the user types the plan name, the user interface can select at least a portion of the typed in plan name and use that portion as a search term. For example, if a user starts to type “Seattle Seahawks” for a plan name, at least a portion of the typed term may be submitted to the software event search component 328 and present for example local events around both the Seattle Seahawks and Seattle Mariners teams since the word “Seattle” is in names of both the teams.

Another example of dynamically generated search criteria, is to use a user's profile information. For example, data for a user from third party applications such as their social networks may be collected and used as criteria on how to interpret which events to present. For example, if a user makes an indication on their profile, or there is a receipt of an indication from a third party system that the user likes the New York Yankees, software event search component 328 would present Yankee's games rather than games of another team. This search criteria may be combined with the plan name as search criteria.

Another example of dynamically generated search criteria, is to use a user's indication of a home locale also known as a “home base.” For example, if a user indicates that the user is a resident of Seattle, the software event search component 328 would present Seattle Mariners games rather than games of another team. As above, this search criteria may be combined with the plan name as search criteria.

Notwithstanding a user's indicated home base, another example of dynamically generated search criteria, is to use the user's plan data. Since the plan data includes event locale information, a user interface could determine that the user will be at a locale other than the user's home base and present events based on that locale. For example, if a user whose home base is Seattle, has a plan to be in New York City for a particular time frame, if the user starts searching for a baseball game, the software event search component 328 may present New York Yankee or New York Mets baseball games instead of Seattle Mariners games. As above, this search criteria may be combined with the plan name as search criteria.

In general, the software social planning application 140 may store past plans and behaviors to create a feedback loop via software plan surfacing component 330 indicating what plans and/or events to present. For example, the software event search component 328 may be coupled to a machine learning software component to help search for user behavior patterns.

In block 604, the software event search component may present event categories prior to presenting events. An event category corresponds to any collection of events. Event categories may include sports teams, musical bands, entertainer/performers, and the like. Event categories may include an entity that generates multiple events. Because that entity would generate multiple events, it may be burdensome to display all events of the entity on a mobile device user interface. Accordingly, the event category may first be shown.

In block 606, a user may select an event category as displayed in block 604. Upon selection, the user interface will display events corresponding to the event category. The display need not simply display the events, but rather may leverage plan information. For example, if Seattle Mariners are presented as a category and are selected by a user, the software event search component 328 may display a scrollable list of local Seattle Mariners games. The display may present the games as a game schedule. Alternatively, the display may present the games as a list of games proximate to wherever the user will be, at home base, or out of town.

### Integrated Data

Presenting of events is generally performed by the software event search component 328, which in turn retrieves event objects from event data store 324. Part of the social planning application's functionality is to integrate with plan, event, preferences and contact data from third party applications such as social networks a user is participating in. FIG. 7 is a flow chart 700, of an exemplary process to integrate social network data.

In block 702, the social planning application 140 receives an indication from the user to select a source of data. The source of data may be the local data of the social planning application, or of an external source of data. The external source of data may be data from a user's third party application such as a social network or calendaring application.

In block 704, upon receiving a selection of a source of data, the user may use a user interface element to indicate via the access control component whether the user has entered credentials. For the local data, the credentials are that of the user's social planning account. For social network data, the credentials are that of the social network. If the user's credential are not valid or have expired, the user may be prompted to enter new credentials. In some embodiments, the access control component may accept credentials of the user's social planning account as proxy credentials for the social network, as a single sign on implementation. In other embodiments, the user may opt to delegate to a social network to validate credentials. For example, the social planning application 140 may be configured to use Facebook™ or Google Plus™ identity services to provide credential management of the local social planning application 140.

Once credentials are authenticated, in block 706, the user may set privileges on subsets of data. Privileges include create, retrieve (read), update and delete privileges on data from the data store. Other privileges include degrees of participation. For example, visibility of a plans, whether notifications are sent, or whether invitations are sent, may be specified in access control lists. Specifically, the user may set privileges global to the data source, and may either prevent access to all but the user, or alternatively may specify access control lists as to which users will have privileges on the data from the data store. The user may set privileges specific to a subset of the data source, specifically plan data, event data, profile data, and contact data. Similarly, the user may set privileges on all of the subset of data or alternatively may specific access control lists as to which users will have privileges on the subset of data.

In block 708, the user may create filters on the data from a data source and/or a subset of data. Upon specifying filters, in block 710, if the data source is an external data source, the data from the data source is loaded into the data stores for the social planning application subject to the filters. For example, event data is imported into event data store 324. Contact data is imported into contacts data store 336. Plan data is imported into plan data store 320. Other data may be imported into the working memory of the social planning application 140. In this way, social networking data may be imported into the social planning application 140.

In block 712, the user may select specific data records, and block all access or otherwise may set access control lists for privileges on a per record basis. For example, privileges for a specific plan, event, contact, or profile record may be subject to access control. As with block 706, privileges are not just create, retrieve, update and delete database operations, but also are privileges specific to step in the Social Planning process.

In block 714, a user may set privileges on a per contact basis such that access control lists by contact override those as specified by access control lists by plan or event. For example, if a contact is to be globally blocked from access to at least a portion of the user's data, the user may specify accordingly. In this way, oversights in access control lists may be remedied. Specifically, a user may neglect to exclude a contact for a plan. By allowing privileges on a contact to override privileges on a plan or event basis, the contact may be excluded automatically without the user having to remember all exclusions.

In general, the foregoing provides a process by which social network data may be integrated into the Social Planning data stores while providing the means of controlling access to the data. Once the data is imported into the Social Planning data stores, such as the plan data store 320, event data store 324, and the contacts data store 336, the social planning application 140 may operate directly on that data and present plans, events and/or interest data accordingly.

### Data Mining and Aggregation

As described above, past plans i.e., plans whose underlying events have already occurred, are not necessarily deleted. Specifically, those data objects in the plan data store 320 remain, and may be mined. FIG. 8 is a flow chart 800 by which data of past plans may be mined, and thereafter aggregated in a data aggregation database 350.

In block 802, a data aggregation software routine identifies a data set from the plan data store 320 comprised of past data plans. The plan objects reference events, invitees and stored communications threads.

In block 804, an administrator may specify filters to filter data from the data set identified in block 802. For example, the administrator may have a dataset of all baseball games, but would only be interested in games referencing the Seattle Mariners, and would accordingly only filter plan data/communications thread data for the Seattle Mariners.

In block 806, the administrator may apply known machine learning and/or pattern detection algorithms. One example algorithm would be to construct a Bayesian decision/inference tree from the data identifying the probabilities of outcomes to input events. Upon application of the algorithms, the administrator would have a result set indicating user preferences and behaviors.

In block 808 based on the result set, the administrator would apply at least some of those preference and behavior data to at least one user's software plan surfacing component 330. Specifically, the administrator may select profiles of events and/or plans (based on events referenced by the plans) that are more likely to be participated in by the user, and thereby forward those profiles to the software plan surfacing component 330. In this way, the social planning application 140 is able to present events and/or plans of increasing interest to a user over time.

### User Interface Specific Use Cases

The likely platform for the social planning application 140 is a mobile device. Because mobile device form factors generally have smaller user interfaces, some users may prefer particular user experiences constituting optimization for mobile devices. FIGS. 9A, 9B and 9C are exemplary of some of such options.

As described with respect to FIG. 5, FIG. 9A is an example of a first view of integrated social planning data, in this case a chat view. In the chat view, various communications threads, each corresponding to a plan is shown. Plans may be highlighted to indicate selection. Alternatively, the text window corresponding to a plan may be tapped or otherwise subject to a user interface gesture to constitute selection.

Upon selection of a plan, the details of the plan may be shown on an event plan as shown in FIG. 9B. Plan data which may include without limitation the event date/time and locale, invitee/participants and their participation status, links to third party data and user generated content may be shown. Options to participate or provide comments, or to socialize, share, or otherwise integrate data to third party applications including a user's social networks may also be shown.

Alternatively, the user may select a user interface element to change to a different view. As described with respect to FIG. 5, a user interface element may be a toggle switch, a button and/or a drop down menu, where a user may specify which views to display. One view is a Calendar View as shown in FIG. 9C. In the Calendar View, a time period corresponding to a selected plan is shown, and different spaces correspond to subsets of time. Here, four days of data is shown, and each space corresponds to a day. For each day, plans of the user and/or contacts are displayed. Indicators of which contacts are participating are shown as well.

One advantage of the Calendar View is that it provides a view in which a user may in view an event in the context of other events, the context of date ranges, the context of locale, or other event aspects impacting planning. The user may opt to save an event, regardless if the user will participate in the event, simply to see the event in any of the aforementioned contexts. In this way, these contexts may influence a user's decision whether or not to participate in an event.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for managing plans for events, comprising:
a processor;
a memory communicatively coupled to the processor;
a plan data store, communicatively coupled to the processor, configured to store one or more plan objects, each plan object comprising event information and invitee information;
a software plan management component resident in the memory, configured to:
receive plan data specified by a plan author, the plan data comprising information for an event and one or more invitees for the event,
create a plan object based on the plan data, and
store the plan object in the plan data store;
a software communications component resident in the memory, configured to create a single interactive communications thread, and wherein the created plan object is associated with the created single interactive communications thread via the software plan management component.

2. The system of claim 1, wherein the software communications component is any one of:
a software chat component,
a software electronic mail component,
a software telephony component, and
a third party software interactive communications component.

3. The system of claim 1, wherein the event information is from an event from a third party application.

4. The system of claim 1, further comprising a software notifications component resident in the memory, configured to send a notification of a change to the plan object, via the software communications component, to at least one of the one or more invitees for the event, via the created single interactive communications thread.

5. The system of claim 1, wherein the software notifications component is further configured to a send the notification via the software communications component to a third party application that the plan author is a participant in.

6. The system of claim 1, wherein the software plan management component is configured to remove an invitee for the event from the plan object and to remove the invitee from the created single interactive communications thread via the software communications component, upon the software plan management component receiving a communication that the invitee has declined participation in the event.

7. The system of claim 1, further comprising a user interface resident in the memory, the user interface having a user interface element having a plan option and a communications option, wherein the user interface is configured to show at least a portion of the plan data when the user interface element is set to the plan option and to show at least a portion of the associated single interactive communications thread, when the user interface element is set to the communications option.

8. The system of claim 1, wherein a plan object in the plan data store may reference another plan object in the plan data store for event information or invitee information or both.

9. The system of claim 1, further comprising a software access control component, wherein access to plan data, the associated single interactive communications thread, or both is restricted by the software access control component.

10. A system for managing plans for events, comprising:
a processor;
a memory communicatively coupled to the processor;
a plan data store, communicatively coupled to the processor, configured to store at least one plan object, a plan object comprising event information and invitee information;
an event data store, configured to store one or more event objects, the event object comprising event information;
a software event search component resident in the memory communicatively coupled to the event data store, configured to retrieve at least one event object from the event data store based on received search criteria;
a software plan management component resident in the memory, configured to:
receive a plan name from a plan author,
retrieve event information from an event object via the software event search component, based at least in part on the received plan name as search criteria,
create a plan object based at least on the plan name and at least some of the retrieved event data, and
store the created plan object in the plan data store.

11. The system of claim 10, wherein the software event search component is further configured to present at least one category of event objects based on the received search criteria, and to retrieve event objects from the event data store based at least on a selection from the plan author of a presented event object category.

12. The system of claim 11, wherein the object category is an event entity, and the retrieved event objects comprise a schedule of events for the event entity.

13. The system of claim 11, wherein the retrieved event data used to create the plan object, is based on a selection from the plan author of one of the retrieved event objects.

14. A system to select a plan to participate in, comprising:
a processor;
a memory communicatively coupled to the processor;
a plan data store, communicatively coupled to the processor, configured to store a at least one plan object, a plan object comprising event information and invitee information;
an event data store, configured to store one or more event objects, an event object comprising event information;
a contact data store, communicatively coupled to the processor, configured to store at least one contact object, a contact object comprising identifiers for contacts of the user
a software event search component resident in the memory communicatively coupled to the event data store, configured to retrieve an event object from the event data store based on received search criteria; and
a user interface resident in the memory configured to display the retrieved event object and an indication that at least one contact of the user is participating in the event of the retrieved event object.

15. The system of claim 14, further comprising a software plan management component resident in the memory, configured to retrieve a plan object from the plan data store, wherein the plan object is storing the participation in the retrieved event object of at least one contact of the user; and
wherein the user interface is further configured to receive an indication that the user is requesting to participate in the event of the retrieved event object, and the software plan management component is configured to store the user's participation in the plan object.

16. The system of claim 15, further comprising a software communications component resident in the memory, configured to send a notification over a single single interactive communications thread, to the at least one contact of the user, that the user is requesting participation in the event of the retrieved event object.

17. The system of claim 14, wherein the user interface is further configured to display a calendar indicating the date and/or time of the event in the plan object and the date and/or time that the user is participating in other events.

18. The system of claim 17, wherein the user interface is further configured to receive the indication that the user is requesting participation in the event via receiving a selection of an user interface element corresponding to a plan object indicated in the calendar.

19. The system of claim 17, further comprising a contact data store, communicatively coupled to the processor, configured to store at least one contact object, a contact object comprising identifiers for contacts of the user;
wherein the other events include events that at least one contact of the user in the contact data store, is participating in, and the calendar is further configured to display the identifiers for the respective contacts participating in the other events.

20. The system of claim 17, wherein the other events displayed by the calendar are filtered by proximity in time, proximity in locale, or both, to the event in the plan object.

21. The system of claim 18, wherein the other events include events from a third party application.

22. The system of claim 21, wherein the other events include events that at least some of the contacts of the user are participating in, the contacts of the user as indicated by a contact data store in a third party application the user is participating in.

23. A system to select a plan to participate in, comprising:
a processor;
a memory communicatively coupled to the processor;
a plan data store, communicatively coupled to the processor, configured to store a at least one plan object, a plan object comprising event information and invitee information;
an event data store, configured to store one or more event objects, an event object comprising event information;
a contact data store, communicatively coupled to the processor, configured to store at least one contact object, a contact object comprising identifiers for contacts of a user, wherein the plan data store is further configured to store a least one plan object of the user and at least one plan object of a contact; and
a software communications component resident in the memory, configured to create a user plan communications thread with the invitees of the at least one plan object of the user and linked to at least one plan object of the user, and to create a contact plan communications thread with the invitees of the at least one plan object of the contact and linked to at least one plan object of the contact and wherein the user plan communications thread and the contact plan communications thread are respectively a single interactive communications thread.

24. The system of claim 23, further comprising a user interface resident in the memory, the user interface having a user interface element having a calendar option and a second option, wherein the user interface is configured to present at least one plan object in a calendar view when the user interface element is set to the calendar option.

25. The system of claim 24, further a software plan management component resident in the memory, configured to add a user as an invitee to a plan object upon receiving an invitation request from the user; and
wherein the calendar view is further configured to send an invitation request to the software plan management component, upon receiving a selection of a user interface element corresponding to a plan object in the calendar view.

26. The system of claim 24, wherein the second view is a communications view configured to display at least one single interactive communications thread; and wherein the calendar view displays a plan object based at least on the displayed single interactive communications thread.

27. The system of claim 24, wherein the second view is a contacts' plans view configured to display at least one plan object a contact is participating in; and wherein the calendar view displays a plan object based at least on the at least one plan object in the contacts' plans view.
